(19) United States
(12) Patent Application Publication
(10) Pub. No.: US 2010/0088835 A1
(43) Pub. Date: Apr. 15, 2010

(54) WORM DRIVE ASSEMBLY FOR AGITATOR

(76) Inventors: James T. Crouch, Danville, KY (US); Edmundo E. Cortez, Danville, KY (US)

Correspondence Address: KING & SCHICKLI, PLLC, 247 NORTH BROADWAY, LEXINGTON, KY, 40507, US

(21) Appl. No.: 12/249,141

(22) Filed: Oct. 10, 2008

(51) Int. Cl. A47L 11/32; B08B 1/04; B08B 5/04

(52) U.S. Cl. 15/41.1; 134/104.2

(57) ABSTRACT

A floor cleaning apparatus is disclosed including a nozzle assembly having an agitator cavity and a handle assembly pivotally connected to the nozzle assembly. The apparatus further includes a rotary agitator carried on the nozzle assembly in the agitator cavity. A dirt collection vessel is carried on either the nozzle assembly or the handle assembly. A drive linkage interconnects a drive motor with the rotary agitator. The drive linkage includes a ring gear including a dog clutch receiver and a dog clutch carried on the rotary agitator. The dog clutch engages the dog clutch receiver to interconnect the drive motor and the rotary agitator during normal operating conditions. In the event of an agitator Jam, the dog clutch functions to interrupt drive to the rotary agitator and protect the drive motor, rotary agitator and drive linkage from damage that might otherwise result from the overload.

### TECHNICAL FIELD AND INDUSTRIAL APPLICABILITY OF THE INVENTION

The present invention relates generally to the floor care equipment field and, more particularly, to a floor cleaning apparatus incorporating a drive linkage between a drive motor and rotary agitator that interrupts drive to the rotary agitator in the presence of an agitator jam.

### BACKGROUND OF THE INVENTION

A vacuum cleaner is an electro-mechanical appliance utilized to effect the dry removal of dust, dirt and other small debris from carpets, rugs, fabrics or other surfaces in domestic, commercial and industrial environments. In order to achieve the desired dirt and dust removal, most vacuum cleaners incorporate a rotary agitator. The rotary agitator is provided to beat dirt and debris from the nap of the carpet or rug while a pressure drop or vacuum is used to force air entrained with this dirt and debris into the nozzle of the vacuum cleaner. The particulate laden air is then drawn into a dirt collection vessel. The air is then drawn through a filter before being directed through the motor of the suction generator to provide cooling. Finally, the air is filtered to remove any fine particles of carbon from the brushes of that motor or other dirt that might remain in the air-stream before being exhausted back into the environment.

It has long been known that the drive train and motor must be protected from damage in the event of an agitator jam whether due to a bearing seizure, a foreign object stuck between the agitator and the nozzle assembly housing, ingestion of the power cord or other event. Presently there are two main types of agitator drive systems employed in the vacuum cleaner industry: (1) belt-drive and (2) gear-drive. All such systems usually include a mechanism to prevent damage to the drive train in the event the agitator becomes jammed.

Belt-drive systems provide an inherent safeguard since the belt itself serves as an inexpensive, expendable weak-link, stretching or breaking at an overload condition and thereby preventing damage to the agitator and motor. Gear-drive systems generally rely upon an overload protector. Such a protector trips or opens a circuit to the agitator drive motor when the current drawn by that motor exceeds a pre-described threshold value anticipated to be produced during an agitator jam. A gear-drive system may, however, sustain gear-tooth fracture as the current ramps up to the threshold value that interrupts power to the drive motor.

The present invention relates to a floor cleaning apparatus equipped with a drive linkage between the agitator and agitator drive motor that incorporates a spring-loaded dog clutch that will interrupt drive to the agitator when the rotary agitator becomes jammed for any reason.

### SUMMARY OF THE INVENTION

In accordance with the purposes of the current invention as described herein, a floor cleaning apparatus is provided comprising a nozzle assembly including an agitator cavity and a handle assembly pivotally connected to the nozzle assembly. A rotary agitator is carried on the nozzle assembly in the agitator cavity. A dirt collection vessel is carried on one of the nozzle assembly and the handle assembly. A drive linkage interconnects a drive motor with the rotary agitator. The drive linkage includes a ring gear having a dog clutch receiver and a dog clutch carried on the rotary agitator. The dog clutch engages the dog clutch receiver to interconnect the drive motor with the rotary agitator. In the event of an agitator jam, the dog clutch functions to interrupt drive from the drive motor to the rotary agitator thereby preventing damage to the apparatus.

More specifically describing the invention, the dog clutch includes a cam carried on a locating lug and a biaser that biases the cam into engagement with the dog clutch receiver. In one possible embodiment the biaser is a compression spring that is received around the locating lug. A cavity provided in the rotary agitator receives the locating lug and compression spring.

In one possible embodiment the drive linkage comprises a worm gear drive. More specifically a worm gear is connected to a drive shaft of the drive motor and the ring gear comprises a cooperating worm wheel connected to the agitator. A dog clutch receiver in the form of an annular series of cam receiving grooves is provided on an inner surface of the worm wheel, The drive motor is interconnected with the rotary agitator when the cam of the dog clutch is received in one of the series of cam receiving grooves. Typically the cam has a radius of curvature of between about 1 mm and about 4 mm. The compression spring has a biasing force of between about 9 N and about 34 N. The cam and the locating lug have a weight between about 0.5 g and about 2.5 g. Further each receiving groove of the dog clutch receiver has a radius of curvature of between about 1 mm and about 4 mm and a depth of between about 0.5 mm and about 2 nm, The drive linkage may include multiple dog clutches on the rotary agitator. Two of the multiple dog clutches may be provided in opposing positions.

Still further describing the invention the rotary agitator typically includes an axle, a body received over the axle and a cleaning element carried on the body. The axle is typically made of metal while the body is typically molded from plastic. The cleaning element is typically a series of bristle tufts. A bearing assembly is provided at each end of the axle to provide for free rotary movement of the agitator relative to the nozzle assembly. The ring gear may be provided on the rotary agitator adjacent one end of the axle. Alternatively, the body may include two sections and the ring gear Inlay be provided on the rotary agitator adjacent a center line of the rotary agitator between those two sections.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the (drawings:

FIG. 1 is a perspective view of the floor cleaning apparatus of the present invention;

FIG. 2 is an exploded perspective view of one possible embodiment of the rotary agitator, drive motor and drive linkage of the present invention;

FIGS. 3A and 3B are both partially schematical and cross sectional views illustrating, respectively, engagement of the ring gear by the dog clutch during normal vacuum cleaner operation whereby power is transmitted from the agitator drive motor to the agitator and the retraction of the dog clutch and the interruption of drive between the drive motor and agitator in the event of an agitator jam condition;

FIGS. 4A and 4B are similar to FIGS. 3A and 3B but illustrate the force vectors and contact points; and

FIG. 5 is an exploded perspective view of an alternative embodiment of the rotary agitator, drive motor and drive linkage of the present invention.

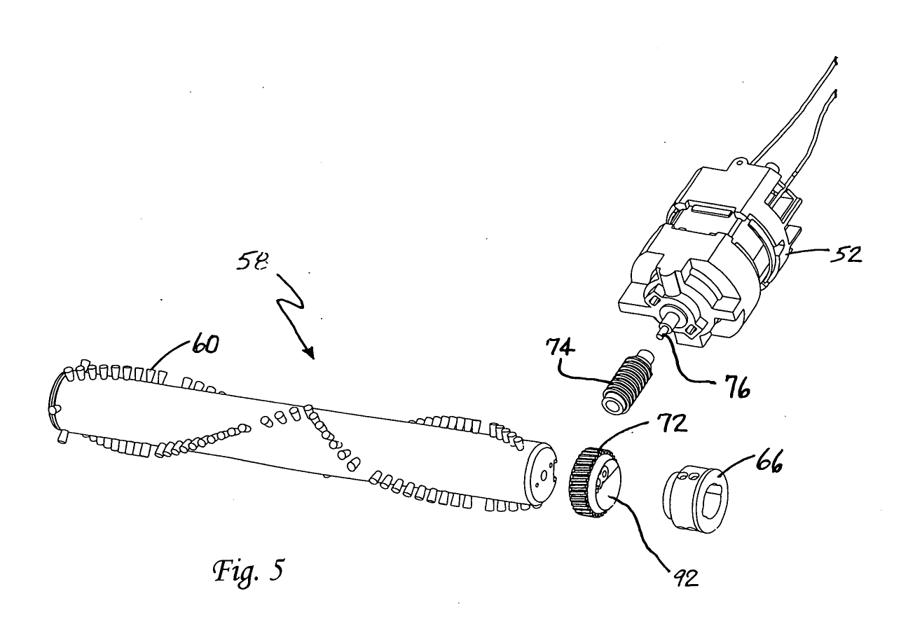

Reference will now be made in detail to the present preferred embodiments of this invention, examples of which are illustrated in the accompanying drawings.

### DETAILED DESCRIPTION OF THE INVENTION

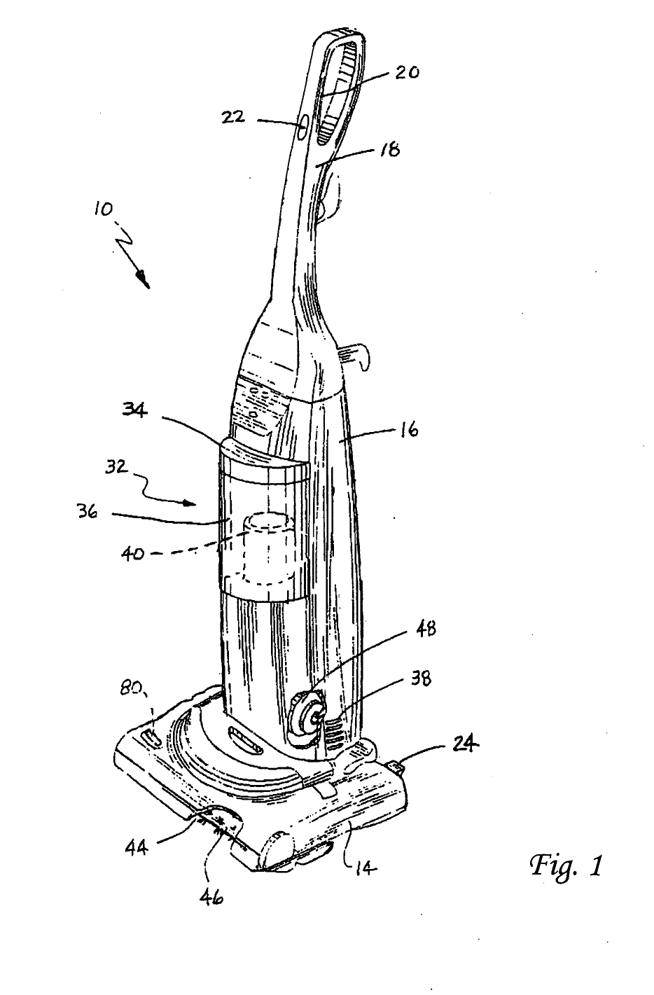

Reference is now made to FIG. 1 showing the upright vacuum cleaner 10 of the present invention. The upright vacuum cleaner 10 includes a housing comprising a nozzle assembly 14 and a handle or canister assembly 16. The handle assembly 16 includes a control handle 18 and a handgrip 20. A control switch 22 is provided for turning the vacuum cleaner 10 on and off. Of course, electrical power is supplied to the vacuum cleaner 10 from a standard electrical wall outlet through an electrical cord (not shown).

A pair of rear wheels (not shown) are provided on the lower portion of the handle assembly 16 and a pair of front wheels (also not shown) are provided on the nozzle assembly 14. Together these wheels support the vacuum cleaner 10 for movement across the floor. To allow for convenient storage of the vacuum cleaner 10, a foot latch (24) functions to lock the canister assembly in an upright position as shown in FIG. 1. When the foot latch is released, the canister assembly 16 may be pivoted relative to the nozzle assembly 14 as the vacuum cleaner 10 is manipulated back and forth to clean the floor.

In the presently illustrated embodiment, the handle assembly 16 includes a cavity adapted to receive and hold a dirt collection vessel 32. The dirt collection vessel 32 may take the form of a dirt cup 34 including a cylindrical sidewall 36, a tangentially directed inlet and an axially directed outlet. A primary filter 40 may be provided in the dirt cup 34 over the axially directed outlet. The primary filter 40 is cylindrical in shape and concentrically received within the cylindrical sidewall 36 of the dirt cup 34. Such a structural arrangement induces cyclonic airflow in the dirt cup 34 and provides for enhanced cleaning efficiency. In an alternative design, the handle assembly 16 includes a closed compartment that houses a filter or vacuum cleaner bag, of a type known in the art, which functions as the dirt collection vessel 32.

The nozzle assembly 14 includes an agitator cavity 44. A rotary agitator 46 is carried on the nozzle assembly 14 in the agitator cavity 44. A suction generator 48, including a final and a cooperating drive motor 52, is carried on the canister assembly 16. The suction generator 48 functions to generate a vacuum air stream for drawing dirt and debris from the surface to be cleaned. In one possible embodiment, the rotary agitator 46 is connected by power take off to the motor 52 of the suction generator 48. In another possible embodiment, the rotary agitator 46 is driven by a separate, dedicated agitator drive motor 52. While the suction generator 48 is illustrated as being carried on the handle assembly 16, it should be appreciated that, alternatively, it could be carried on the nozzle assembly 14 if desired.

During normal operation, the rotary agitator 46 is driven by the motor 52 of the suction generator 48 and functions to beat dirt and debris from the nap of an underlying carpet. The suction generator 48 functions to draw a vacuum air stream into the agitator cavity 44. Dirt and debris from the carpet is entrained in the air stream, which is then drawn by the suction generator 48 into the dirt cup 34, Dirt and debris is captured in the dirt cup 34 while relatively clean air is drawn through the primary filter 40. That air stream passes over the motor 52 of the suction generator 48 to provide cooling before being exhausted through a final filter, such as a HEPA filter (not shown) before being exhausted through an exhaust port 38 into the environment.

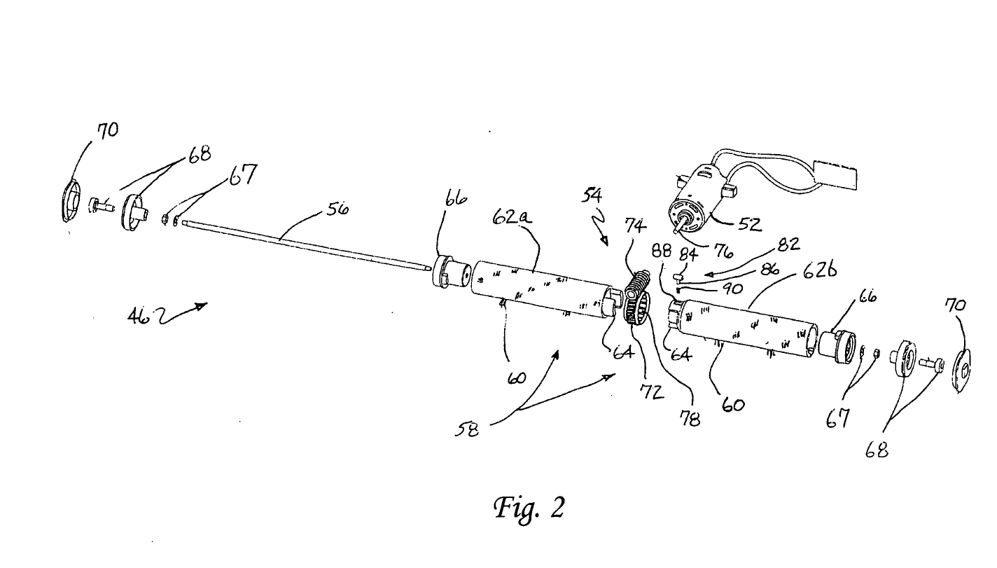

A first embodiment of the rotary agitator 46, drive motor 52 and drive linkage 54 is illustrated in detail in FIG. 2. As illustrated, the rotary agitator 46 comprises an axle 56, a body 58 received over the axle and a cleaning element 60 carried on the body. Typically the axle 56 is made of a strong metal such as steel while the body 48 is molded from a plastic such as ABS, nylon, polyvinyl chloride, or polypropylene. In the illustrated embodiment, the cleaning element 60 comprises bristle tufts. It should be appreciated, however, that substantially any other type of cleaning element known in the art may be utilized including but not limited to a beater bar, wiper, squeegee, or the like.

More specifically describing the embodiment illustrating in FIG. 2, the body 58 comprises two sections 62a, 62b that are keyed together by cooperating lugs 64 at the center line of the agitator body 58. The body 58 is hollow and the two opposing ends of the body are closed by end caps 66. Cooperating nuts and washers 67 are received over and secured to threaded ends of the axle 56 to hold the agitator body 58 and axle 56 together. Each of the end caps 66 has a cavity that holds a bearing assembly 68. The bearing assemblies 68 at each end of the rotary agitator 46 allow the rotary agitator to rotate or spin freely with respect to the bearing caps 70, which are provided at the outermost ends of the rotary agitator 46, said caps incorporating flanges that allow the mounting of the rotary agitator in the nozzle assembly 14 in a manner known in the art.

As should be further appreciated from reviewing FIGS. 2,3a and 3b, the drive linkage 54 includes a ring gear 72 in the form of a worm wheel. The ring gear 727 meshes with a worm gear 74 that is connected to the drive shaft 76 of the drive motor 52. The interface of the ring gear 72 includes a dog clutch receiver 78 comprising an annular series of cam receiving grooves 80. Typically the ring gear 72 is made from metal such as SMF 5040.

The ring gear 72 is mounted on the agitator body 58 at the centerline thereof overlying the lugs 64 that interconnect and key the two sections 62a, 62b of the body 58 together. As molded, the lugs 64 are inset relative to the outer circumference of the rest of the body 58 so as to form a channel to receive and hold the ring gear 72 in position.

The drive linkage 54 also includes a dog clutch, generally designated by reference numeral 82. The dog clutch 82 comprises a cam 84 carried on a locating lug 86. The dog clutch 82 is carried on the rotary agitator 58. More specifically, the lug 64 on the body section 62b includes a cavity 88. The locating lug 86 of the dog clutch 82 is received in this cavity 88. A biaser, in the form of a compression spring 90, is received around the locating lug 86 and held in the cavity 88.

The dog clutch 82 is typically made from a metal such as steel. The cam 84 on the dog clutch typically has a radius of curvature of between about 1 mm and about 4 mm. The compression spring 90 typically has a biasing force of between about 9 N and about 34 N. The cam 84 and locating lug 86 of the dog clutch 82 typically have a weight of between about 0.5 g and about 2.5 g. Each receiving groove 80 of the dog clutch receiver 78 typically has a radius of curvature of between about 1 mm and about 4 mm and a depth of between about 0.5 mm and about, 2 mm.

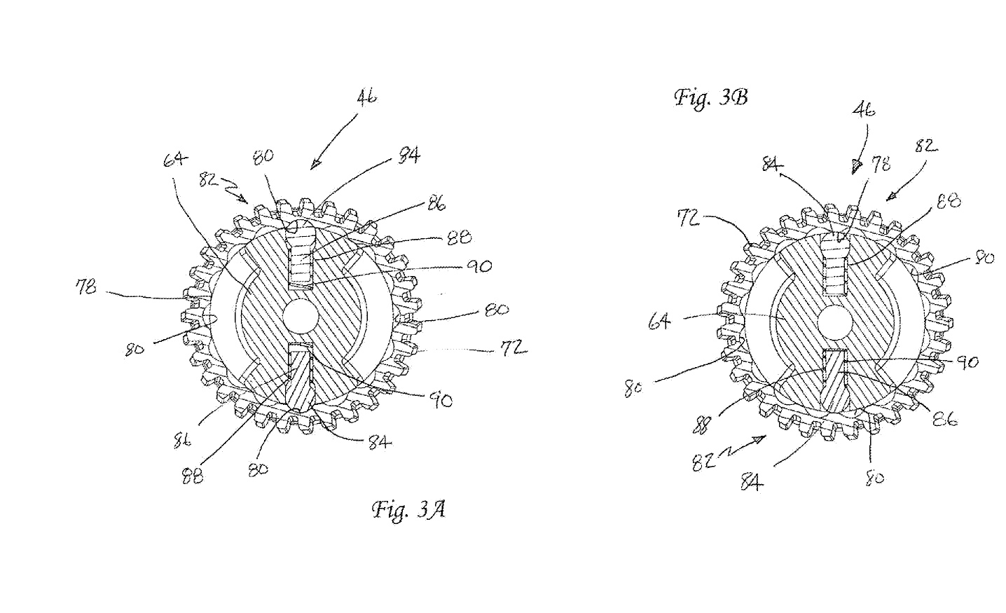

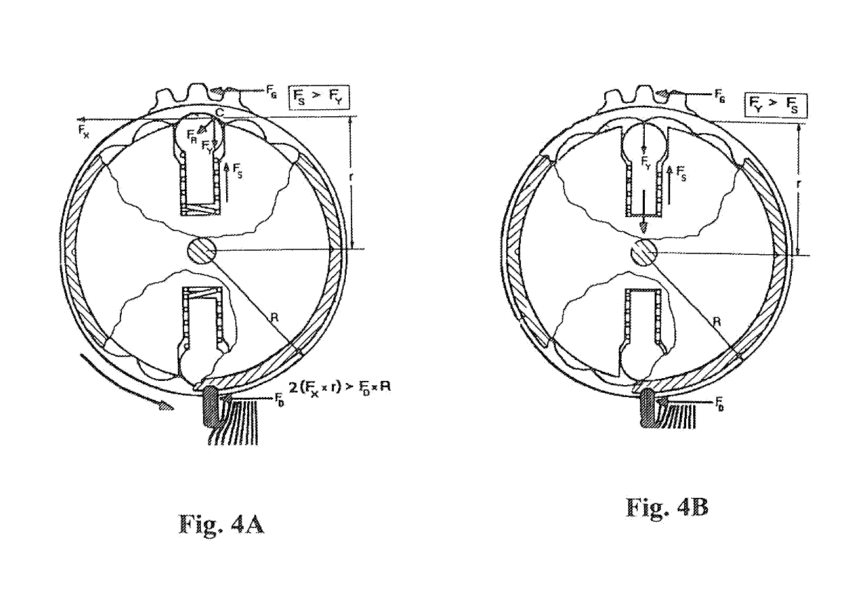

As illustrated in FIGS. 3A and 4A, during normal vacuum cleaner operation, the biasing compression spring 90 and the centrifugal force acting upon the dog clutch 82 as a result of the high speed rotation of the agitator 46 causes the cam 84 to fully nest and stay within one of the grooves 80 of the dog clutch receiver 78. This functions to key the ring gear 72 to the body 58 of the rotary agitator 46 thereby interconnecting the drive motor 52 with the rotary agitator 46. Thus, during normal operating conditions, the drive linkage 54 maintains a radially directed resultant force F_{R} on the cam 84 at the point C. This force may be represented by additive sub-component forces F_{X} and F_{Y}. Within normal running torque ranges, the spring force F_{S} of the compression spring 90 exceeds F_{Y} such that the cam remains in the home position fully nested in the groove 80 of the dog clutch receiver 78 so as to transfer gear torque to the agitator 46. In the illustrated embodiment, two opposing dog clutches 82 are illustrated and the running torque is 2(F_{X}*r). During normal operation 2(F_{X}*r) exceeds the opposing torque F_{O}*R generated by the drag force F_{O} of the carpet/tuft interaction.

In the event the agitator becomes jammed for any reason (see FIG. 4B), then F_{O} increases to a maximum Fₘₐₓ governed by the maximum torque capability of the drive motor 52 and 2(F_{X}*r)=Fₘₐₓ*R. At this value of F_{X}, the additive F_{Y} is increased to exceed F_{S}, resulting in the compression of the spring 90 and the retraction of the cam 84 so that the cam is no longer nested in a groove 80 of the dog clutch receiver 78. The disengagement of the cam 84 of the dog clutch 82 from the groove 80 interrupts drive between the motor 52 and the rotary agitator 46. More specifically, the worm gear 74 on the drive shaft 76 of the drive motor 52 continues to turn the ring gear 72 but the ring gear is no longer keyed to the agitator body 58. Thus, the meshing gears 72, 74 continue to turn so that the teeth are not damages but the agitator 46 is disconnected from the ring gear 72 and remains stationary. In this way, damage to the rotary agitator 46, the drive linkage 54 and the drive motor 52 is prevented in a jam condition.

An alternative embodiment of the rotary agitator 46 is illustrated in FIG. 4. In this embodiment, the agitator body 58 is a single piece that accepts a fitting 92 at one end thereof for receiving one or more dog clutches 82 and the ring gear 72 in the manner described above. The resulting drive linkage 54 functions in the manner previously described in the first embodiment illustrated in FIG. 2 to interrupt drive in the event of a jam and prevent damage from occurring to the drive motor 52, drive linkage 54 or the rotary agitator 46.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated, All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A floor cleaning apparatus comprising:
a nozzle assembly including an agitator cavity;
a handle assembly pivotally connected to said nozzle assembly;
a rotary agitator carried on said nozzle assembly in said agitator cavity;
a drive motor;
a dirt collection vessel carried on one of said nozzle assembly and said handle assembly; and
a drive linkage interconnecting said drive motor with said rotary agitator, said drive linkage including;
(a) a ring gear including a dog clutch receiver; and
(b) a dog clutch carried on said rotary agitator, said dog clutch engaging said dog clutch receiver to interconnect said drive motor and said rotary agitator.

2. The apparatus of claim 1, wherein said dog clutch includes a cam carried on a locating lug and a biaser that biases said cam into engagement with said dog clutch receiver.

3. The apparatus of claim 2, wherein said biaser is a compression spring received around said locating lug.

4. The apparatus of claim 3, wherein said rotary agitator includes a cavity and said locating lug and compression spring are received in said cavity.

5. The apparatus of claim 4, wherein said dog clutch receiver is an annular series of cam receiving grooves.

6. The apparatus of claim 5, wherein said drive linkage includes a worm gear connected to a drive shaft of said drive motor and said ring gear is a cooperating worm wheel connected to said agitator.

7. The apparatus of claim 6, wherein said dog clutch receiver is provided on an inner surface of said worm wheel.

8. The apparatus of claim 7, wherein said rotary agitator includes an axle, a body received over said axle and a cleaning element carried on said body.

9. The apparatus of claim 8, wherein said axle is metal, said body is molded from plastic and said cleaning element is a series of bristle tufts.

10. The apparatus of claim 9, wherein a bearing assembly is provided at each end of said axle.

11. The apparatus of claim 10, wherein said ring gear is provided on said rotary agitator adjacent one end of said axle.

12. The apparatus of claim 10, wherein said body includes two sections and said ring gear is provided on said rotary agitator adjacent a centerline of said rotary agitator between said two sections.

13. The apparatus of claim 3, wherein said cam has a radius curvature of between about 1 mm and about 4 mm.

14. The apparatus of claim 13, wherein said compression spring has a biasing force of between about 9 N and about 34 N.

15. The apparatus of claim 14, wherein said cam and said locating lug have a weight of between about 0.5 g and about 2.5 g.

16. The apparatus of claim 15, wherein each receiving groove has a radius of curvature of between about 1 mm and about 4 mm and a depth of between about 0.5 mm and about 2 mm.

17. The apparatus of claim 1, wherein said drive linkage includes multiple dog clutches on said rotary agitator.

18. The apparatus of claim 17, wherein two of said multiple dog clutches are opposing.

19. The apparatus of claim 1, wherein said drive motor also drives a fan to produce a suction air flown to draw dirt and debris into said apparatus.

20. The apparatus of claim 1, wherein said drive motor is dedicated to driving said rotary agitator.
